(19) United States
(12) Patent Application Publication
(10) Pub. No.: US 2012/0156788 A1
(43) Pub. Date: Jun. 21, 2012

(54) BIOLOGICAL MATERIAL TEST DEVICE AND METHOD OF CONTROLLING THE SAME

(75) Inventors: Seok Ho Kim, Bucheon-si (KR); Hyug Rae Cho, Seoul (KR); Su Jung Han, Seongnam-si (KR)

(73) Assignee: SAMSUNG ELECTRONICS CO., LTD., Suwon-si (KR)

(21) Appl. No.: 13/314,653

(22) Filed: Dec. 8, 2011

(30) Foreign Application Priority Data
Dec. 21, 2010 (KR) 10-2010-0131264

(51) Int. Cl. G01N 35/00; B01J 19/00

(52) U.S. Cl. 436/50; 422/63

(57) ABSTRACT

A test device to automatically close an opening and closing unit when a predetermined amount of time has elapsed in a state that the opening and closing unit is open, and a method of controlling the same. The test device includes an opening and closing unit which opens and closes the test device; a display unit which displays information regarding the test device; and a controller which closes the opening and closing unit when a predetermined amount of time has elapsed while the opening and closing unit is open, and displays on the display unit a time remaining until the predetermined amount of time has elapsed.

### CROSS-REFERENCE TO RELATED APPLICATION

This application claims priority from Korean Patent Application No. 2010-131264, filed on Dec. 21, 2010 in the Korean Intellectual Property Office, the disclosure of which is incorporated herein by reference.

### BACKGROUND

1. Field

Apparatuses and methods consistent with exemplary embodiments relate to a test device in which a constant temperature needs to be maintained during test, and a method of controlling the same.

2. Description of the Related Art

In test devices which analyze and test various biological materials separated from a human body, a constant temperature needs to be maintained during analysis and testing. In particular, various tests need to be performed at the same temperature as human body temperature such that reactions proceed smoothly. Therefore, a constant temperature needs to be maintained in the devices when performing analysis and testing.

If a device including a biological material to be tested and various reagents reacting therewith, for example, a microfluidic device such as a bio disc is loaded into a operational space of a test device, an optimal temperature required for analyzing and testing the biological material is maintained while the biological material is analyzed and tested.

In the case where a biological material is analyzed using a test device, a loader on which a microfluidic device is loaded or a door to open or close the test device may be left open when the microfluidic device is loaded into the test device in order to analyze the biological material or when the microfluidic device is taken out of the test device upon completion of the analysis of the biological material.

In the related art, the loader returns to an original position such that the test device is isolated from an external environment only when a user directly returns the loader to the inside of the test device, that is, only when the user closes the loader. However, if the user does not return the loader to the inside of the test device such that the loader of the test device is left open, the temperature of the test device may be changed due to an external temperature.

In order to prevent changes in temperature and maintain a constant temperature, the test device consumes more power and thus efficiency of the test device is deteriorated.

### SUMMARY

Exemplary embodiments provide a test device in which an opening and closing unit is automatically closed an opening and closing unit when a predetermined amount of time has elapsed in a state that the opening and closing unit is opened, and a method of controlling the same.

In accordance with an aspect of an exemplary embodiment, there is provided a test device including: an opening and closing unit which opens and closes the test device; a display unit which displays information regarding the test device; and a controller which closes the opening and closing unit when a predetermined amount of time has elapsed while the opening and closing unit is open, and displays on the display unit a time remaining until the predetermined amount of time has elapsed.

The display unit may be a touch panel display.

The opening and closing unit may open or close the test device.

The opening and closing unit may be a tray type loader which is opened or closed in a sliding manner.

The opening and closing unit may be a top loading type loader which is opened or closed by vertical movement.

The controller may display a message that the opening and closing unit will be closed when the predetermined amount of time has elapsed on the display unit.

The controller may update the remaining time every second and display the remaining time on the display unit.

The controller may generate a sound signal indicating that the opening and closing unit is being closed when the opening and closing unit is being closed.

The controller may close the opening and closing unit regardless of the remaining time, if a command to close the opening and closing unit is input.

The test device may test a biological material.

In accordance with an aspect of another exemplary embodiment, there is provided a method of controlling a test device, the method including displaying a message that the test device will be closed when a predetermined amount of time has elapsed; displaying a time remaining until the predetermined amount of time elapses; and closing the test device when a predetermined amount of time has elapsed.

The predetermined amount of time may be about 1 minute or less.

The displaying a message that the test device will be closed when the predetermined amount of time has elapsed may include displaying the message that an opening and closing unit of the test device will be closed when the predetermined amount of time has elapsed on a display unit of the test device.

The displaying the remaining time may include updating the remaining time every second and displaying the remaining time on a display unit of the test device.

The closing the test device when the predetermined amount of time has elapsed may include closing an opening and closing unit of the test device while generating a sound signal when the predetermined amount of time has elapsed.

The test device may test a biological material.

### BRIEF DESCRIPTION OF THE DRAWINGS

The above and/or other aspects will become apparent and more readily appreciated from the following description of exemplary embodiments, taken in conjunction with the accompanying drawings of which:

FIG. 1 is a block diagram showing the configuration of a test device according to an exemplary embodiment;

FIG. 2 is a perspective view showing the test device according to the exemplary embodiment;

FIG. 3 is a flowchart illustrating a method of controlling the test device according to the exemplary embodiment; and

FIGS. 4A to 4C are conceptual diagrams showing images displayed on a display unit of the test device according to the exemplary embodiment.

### DETAILED DESCRIPTION

Reference will now be made in detail to exemplary embodiments with reference to the accompanying drawings, wherein like reference numerals refer to like elements throughout.

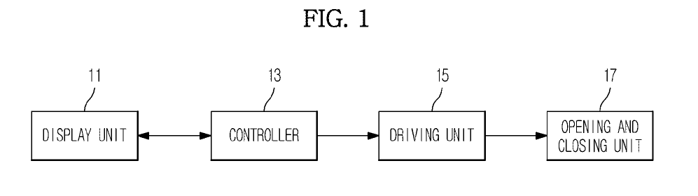

FIG. 1 is a block diagram showing the configuration of a test device according to an exemplary embodiment.

The test device 10 according to the exemplary embodiment analyzes or tests various samples. As the test device 10, various devices may be used according to the kind of sample to be analyzed.

The sample may include, but is not limited to, DNA, oligonucleotide, RNA, PNA, ligand, receptor, antigen, antibody, milk, urine, saliva, hair, crop samples, meat samples, bird samples, animal samples, processed food samples, oral cells, tissue samples, semen, protein, or other biological materials. The material to be analyzed may include, but is not limited to, protein, antigen, antibody, DNA, RNA, oligonucleotide, receptor, etc. For example, if urine is used as a sample, examples of the material to be analyzed include blood, glucose, ascorbic acid, ketone, protein, sugar, urobilinogen, bilirubin, etc.

Hereinafter, a blood tester to analyze blood is described as an example of the test device 10. However, other embodiments are not limited to a blood tester.

As shown in FIG. 1, the test device 10 according to the exemplary embodiment includes a display unit 11 to display messages, such as a state of the device, to a user, an opening and closing unit 17 to open or close the test device 10, a driving unit 15 to drive the opening and closing unit 17 and a controller 13 to control the display unit 11 and the driving unit 15.

The display unit 11 displays various messages, such as states of the device, to the user using characters or images.

The display unit 11 may be a touch panel display. A user directly touches various input buttons displayed on the display unit 11 so as to input a variety of information and commands to operate the device. Thus, the test device operates according to input information and commands. That is, the display unit 11 may perform an input function to input various commands to perform the functions of the device, in addition to the display function to display the state of the device. Alternatively, an input unit including various input buttons may be separately provided. Although the touch panel display is described as an example of the display unit 11, other embodiments are not limited thereto.

The opening and closing unit 17 may be a door which opens to provide access to the interior of the test device 10 in order to insert a microfluidic device including blood and various reagents reacting with the blood to test the blood, such as a bio disc, into the test device 10 or take the microfluidic device out of the test device 10.

The opening and closing unit 17 may be a reciprocally movable loader which moves from the inside to the outside of the test device 10 in order to mount the microfluidic device or remove the microfluidic device upon completion of blood analysis, and moves from the outside to the inside of the test device 10 when the microfluidic device is mounted or removed.

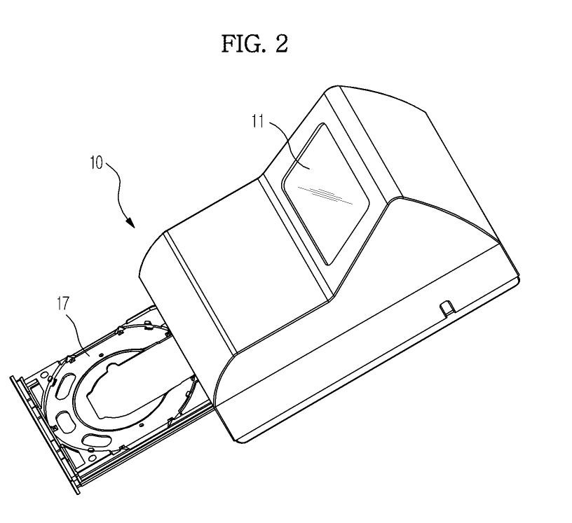

For example, the opening and closing unit 17 may be a tray type loader (see FIG. 2) or top loading type loader which may move between the inside and the outside of the test device 10. These types of the opening and closing unit 17 are only exemplary and other embodiments are not limited thereto. Hereinafter, a tray type loader which moves in a sliding manner will be described as an example of the opening and closing unit 17. Hereinafter, the opening and closing unit 17 will be referred to as a “loading tray.”

When the loading tray 17 moves to the inside of the test device 10, i.e., is closed, the interior of the test device 10 is isolated from the outside of the test device and, when the loading tray 17 moves to the outside of the test device 10, i.e., is open, the interior of the test device 10 may be influenced by the external environment in a state of being isolated from the outside of the test device. For example, the test device may be influenced by external temperature.

The driving unit 15 provides driving force to the loading tray 17 according to a driving control signal of the controller 13 such that the loading tray 17 moves to the inside and the outside of the test device 10.

The controller 13 is a microcomputer to control the overall function of the test device 10 according to information and commands input via the display unit 11 or the separate input unit.

The controller 13 may generate a control signal to maintain the temperature of the interior of the test device 10, into which the microfluidic device is inserted, constant, while blood is tested, and control the driving unit 15 so as to control the opening and closing of the loading tray 17 in order to insert the microfluidic device into the test device 10 or take the microfluidic device out of the test device 10.

If a user does not input a command to leave the loading tray 17 of the test device 10 open after moving to the outside of the test device 10 in order to mount the microfluidic device or remove the microfluidic device, the controller 13 may control the driving unit 15 such that the loading tray 17 is automatically closed when a predetermined amount of time has elapsed.

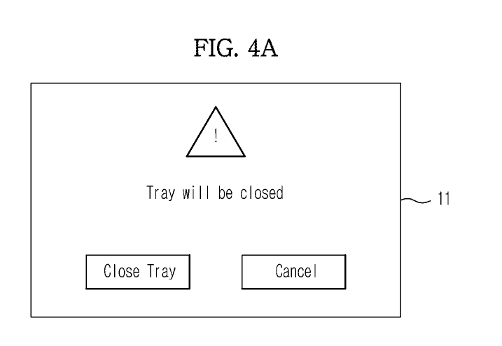

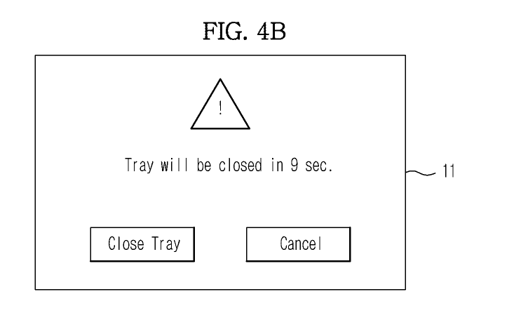

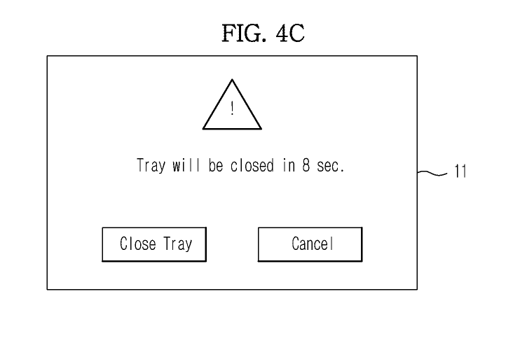

That is, the controller 13 may display a message indicating that the loading tray 17 will be closed when the predetermined amount of time has elapsed on the display unit 11 if the loading tray 17 is left open (see FIG. 4A).

When the message indicating that the loading tray 17 will be closed when the predetermined amount of time has elapsed is displayed on the display unit 11, the user recognizes that the loading tray 17 has been left open. In this case, the user may input a command to close the loading tray 17 before the predetermined amount of time has elapsed. If the user inputs the command to close the loading tray 17 before the predetermined amount of time has elapsed, the controller 13 controls the driving unit 15 to close the loading tray 17 regardless of the time remaining until the predetermined amount of time elapses. If the user does not input the command, the controller 13 continuously counts the remaining time.

The controller 13 may display the time remaining until the loading tray 17 is closed on the display unit 11. For example, the remaining time displayed on the display unit 11 may be updated every second (see FIGS. 4B and 4C). The remaining time is displayed on the display unit 11 such that the user recognizes when the loading tray 17 is open.

The controller 13 may generate a sound signal to be output, for example, via a speaker (not shown), while displaying the message indicating that the loading tray 17 will be closed when the predetermined amount of time has elapsed on the display unit 11. In order to indicate the remaining time, a sound signal may be generated every predetermined unit time, for example, every second. The message indicating that the loading tray 17 will be closed when the predetermined amount of time has elapsed is displayed on the display unit 11, the remaining time is displayed and the sound signal is generated, such that the user recognizes that the loading tray 17 has been left open. Therefore, it is possible to notify the user that the loading tray 17 will be closed when the predetermined amount of time has elapsed and how much time has elapsed or remains.

The controller 13 controls the driving unit 15 such that the loading tray 17 is automatically closed without the user command to close the loading tray 17, when the predetermined amount of time has elapsed. The controller 13 may generate a sound signal to notify the user that the loading tray 17 is being closed, when the loading tray 17 is being closed. The sound signals have different patterns such that the user recognizes different information of the sound signals. The patterns of a sound signal indicating that the loading tray 17 will be closed when the predetermined amount of time has elapsed, a sound signal indicating the remaining time and a sound signal indicating that the loading tray 17 is being closed are differently set such that the user recognizes the information of the sound signals.

The predetermined amount of time required to close the loading tray 17 may be set in advance and input to the controller 13. For example, a time of 30 seconds may be input to the controller 13. If the command to close the loading tray 17 is not input during 20 seconds, the controller 13 displays the message indicating that the loading tray 17 will be closed and the remaining time of 10 seconds, updates the remaining time every second, and closes the loading tray 17 when the remaining time of 10 seconds has elapsed. This is only exemplary and embodiments of the present invention are not limited thereto.

FIG. 2 is a perspective view showing the test device 10 according to the exemplary embodiment.

In FIG. 2, a loader on which a microfluidic device may be mounted that is, a slidable loading tray, is shown as an example of the opening and closing unit 17. FIG. 2 shows a state in which the loading tray 17 is taken out of the test device 10. The disc-shaped microfluidic device may be mounted on a circular groove of the loading tray 17. In FIG. 2, the test device 10 includes the display unit 11 to display the state of the device. The display unit 11 may be a touch panel display. A user may touch command input buttons on the display unit 11 so as to input various commands. The test device 10 shown in FIG. 2 is only exemplary and the embodiments of the present invention are not limited thereto.

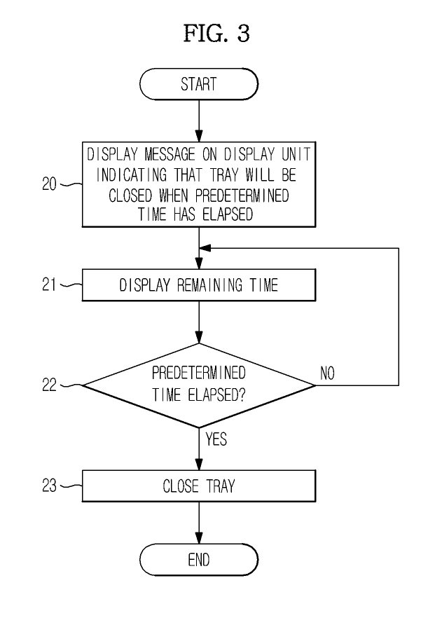

FIG. 3 is a flowchart illustrating a method of controlling the test device 10 according to the exemplary embodiment.

As shown in FIG. 3, if the user does not input a command to close the loading tray 17 such that the loading tray 17 is left open, the controller 13 displays the message indicating that the loading tray 17 will be closed when the predetermined amount of time has elapsed on the display unit 11 (20). For example, a message “Tray will be closed” or “Tray will be closed in 10 seconds” may be displayed on the display unit 11. The controller 13 may generate a sound signal along with the message indicating that the loading tray 17 will be closed when the predetermined amount of time has elapsed.

If the message indicating that the loading tray 17 will be closed when the predetermined amount of time has elapsed, the controller 13 counts down the remaining time and displays the remaining time on the display unit 11. That is, the remaining time is updated every second and displayed on the display unit 11 (21). For example, a message indicating the remaining time, such as “Tray will be closed in 9 seconds” or “Tray will be closed in 8 seconds”, may be displayed on the display unit 11. The controller 13 may generate and output a sound signal indicating the remaining time every unit time, for example, every second, along with the message indicating the remaining time on the display unit 11.

The controller 13 determines whether the predetermined amount of time has elapsed every unit time, for example, every second (22). If it is determined that the predetermined amount of time has elapsed, the controller controls the driving unit 15 so as to close the loading tray 17 (23). When the loading tray 17 is closed, a sound signal indicating that the loading tray 17 is being closed may be generated and output.

If it is determined that the predetermined amount of time has not elapsed, the method returns to Operation 21 of counting down the remaining time and displays the remaining time on the display unit 11. Such a determination may be made by determining whether the remaining time is zero every second.

FIGS. 4A to 4C are conceptual diagrams showing images displayed on a display unit 11 of the test device 10 according to the exemplary embodiment.

Referring to FIG. 4A, if the user command to close the loading tray 17 is not input and the loading tray 17 is left open, the message indicating that the loading tray 17 will be closed may be displayed on the display unit 11 and a button to input the command to close the loading tray 17 may be displayed. The user may touch an image indicating “Close Tray” so as to input the command to close the loading tray 17. If the command to close the loading tray 17 is input, the controller 13 controls the driving unit 15 such that the loading tray 17 is immediately closed regardless of the remaining time. The user may touch an image indicating “Cancel” so as to cancel the mode to automatically close the loading tray 17 when the predetermined amount of time has elapsed. The image of the display unit 11 shown in FIG. 4A is only exemplary and embodiments of the present invention are not limited thereto.

Referring to FIGS. 4B and 4C, the time remaining until the loading tray is closed may be updated and displayed on the display unit 11. Even in this case, the user may touch an image indicating “Close Tray” so as to input the command to close the loading tray 17. If the command to close the loading tray 17 is input, the controller 13 controls the driving unit 15 such that the loading tray 17 is immediately closed regardless of the remaining time. The user may touch an image indicating “Cancel” so as to cancel the mode to automatically close the loading tray 17 when the predetermined amount of time has elapsed. The image of the display unit 11 shown in FIG. 4A is only exemplary and other embodiments are not limited thereto.

According to the above-described exemplary embodiments, it is possible to minimize or prevent a decrease in temperature in order to maintain a constant temperature, by automatically closing the opening and closing unit when the predetermined amount of time has elapsed after the opening and closing unit of the test device is opened.

Further, is possible to prevent the opening and closing unit from being left open for an extended period of time and to prevent excessive power consumption for maintaining a constant temperature.

Further still, is possible to prevent the opening and closing unit from being contaminated by foreign materials and prevent device failure, by displaying the time remaining until the opening and closing unit is closed to the user.

Although a few exemplary embodiments have been shown and described, it would be appreciated by those skilled in the art that changes may be made in these embodiments without departing from the principles and spirit of the inventive concept, the scope of which is defined in the claims and their equivalents.

What is claimed is:

1. A test device comprising:
an opening and closing unit which opens and closes the test device;
a display unit which displays information regarding the test device; and
a controller which closes the opening and closing unit when a predetermined amount of time has elapsed while the opening and closing unit is open, and displays on the display unit a time remaining until the predetermined amount of time has elapsed.

2. The test device according to claim 1, wherein the display unit is a touch panel display.

3. The test device according to claim 1, further comprising a driving unit which provides driving force to open and close the opening and closing unit, and is controlled by the controller.

4. The test device according to claim 1, wherein the opening and closing unit is a tray type loader which is configured to open and close in a sliding manner.

5. The test device according to claim 1, wherein the opening and closing unit is a top loading type loader which is opened or closed by vertical movement.

6. The test device according to claim 1, wherein the controller displays on the display unit a message that the opening and closing unit will be closed when the predetermined amount of time has elapsed.

7. The test device according to claim 1, wherein the controller updates the remaining time every second and displays the remaining time on the display unit.

8. The test device according to claim 1, wherein the controller generates a sound signal indicating that the opening and closing unit is being closed when the opening and closing unit is being closed.

9. The test device according to claim 1, wherein the controller closes the opening and closing unit regardless of the time remaining until the predetermined amount of time elapses, if a command to close the opening and closing unit is input.

10. The test device according to claim 1, wherein the test device tests a biological material.

11. A method of controlling a test device, the method comprising:
displaying a message that the test device will be closed when a predetermined amount of time has elapsed;
displaying a time remaining until the predetermined amount of time elapses; and
closing the test device when a predetermined amount of time has elapsed.

12. The method according to claim 11, wherein the predetermined amount of time is about 1 minute or less.

13. The method according to claim 11, wherein the displaying a message that the test device will be closed when the predetermined amount of time has elapsed comprises displaying on a display unit of the test device the message that an opening and closing unit of the test device will be closed when the predetermined amount of time has elapsed.

14. The method according to claim 11, wherein the displaying the remaining time comprises updating the time remaining until the predetermined amount of time elapses every second and displaying on a display unit of the test device the time remaining until the predetermined amount of time elapses.

15. The method according to claim 11, wherein the closing the test device when the predetermined amount of time has elapsed comprises closing an opening and closing unit of the test device while generating a sound signal when the predetermined amount of time has elapsed.

16. The method according to claim 11, wherein the test device tests a biological material.

17. A test device to test biological material, the test device comprising:
a loader which closes by moving into the test device to insert a microfluidic device containing the biological material into the test device, and opens by moving out of the test device to remove the microfluidic device from the test device;
a driving unit which provides driving force to open and close the loader; and
a controller which controls the driving unit to automatically close the loader when a predetermined amount of time has elapsed while the loader is open.

18. The test device according to claim 17 further comprising a display unit which displays information regarding the test device,
wherein the controller displays on the display unit a time remaining until the predetermined amount of time has elapsed.

19. The test device according to claim 17 further comprising a display unit which displays information regarding the test device,
wherein the controller displays on the display unit a message that the loader will be closed when the predetermined amount of time has elapsed.

20. The test device according to claim 17, wherein the loader is one of a loading tray which is configured to slide into and out of the test device in a horizontal direction, and a top loading type loader which moves into and out of the test device in a vertical direction.
